(19) United States
(12) Patent Application Publication
(10) Pub. No.: US 2021/0031313 A1
(43) Pub. Date: Feb. 4, 2021

(54) METHOD FOR MOUNTING A VALVE NEEDLE AND A BEARING BUSH IN AN EXPANSION VALVE FOR AN AIR CONDITIONING SYSTEM

(71) Applicant: Mahle International GmbH, Stuttgart (DE)

(72) Inventors: Daniel Dobernig, Poggersdorf (DE); Werner Schadler, Leibnitz (AT); Mario Wetzl, Kuehnsdorf (AT)

(21) Appl. No.: 16/945,752

(22) Filed: Jul. 31, 2020

(30) Foreign Application Priority Data
Aug. 1, 2019 (DE) 10 2019 211 552.7

(51) Int. Cl. B23P 15/00; F25B 41/06

(52) U.S. Cl. CPC B23P 15/001; F25B 41/062

(57) ABSTRACT

A method for mounting a valve needle and a bearing bush in an expansion valve for an air conditioning system may including providing a bearing bush and providing a valve needle. The bearing bush may include a circumferential wall. The valve needle may include a mounting groove having two groove flanks and a groove base. The method may also include forming a needle-bush arrangement in which the bearing bush may be received in the mounting groove via one of (i) axial sliding-in the valve needle into the bearing bush and (ii) axial sliding-on the bearing bush onto the valve needle. The method may further include mounting the needle-bush arrangement in a mounting bore of the expansion valve, which may include (i) forming a press fit between the circumferential wall and the mounting bore, and/or (ii) forming a clearance fit between the groove base and the bearing bush.

### CROSS-REFERENCE TO RELATED APPLICATIONS

This application claims priority to German Patent Application No. DE 10 2019 211 552.7, filed on Aug. 1, 2019, the contents of which is hereby incorporated by reference in its entirety.

### TECHNICAL FIELD

The invention relates to a method for mounting a valve needle and a bearing bush in an expansion valve for an air conditioning system and to an expansion valve having a valve needle and bearing bush mounted by means of such a method.

### BACKGROUND

Conventional methods for mounting a valve needle and a bearing bush in an expansion valve for an air conditioning system have been known for some time. Usually, with such methods, a bearing bush with a bush outer diameter matched to a mounting inner diameter of a mounting bore of an expansion valve is pressed into the mounting bore forming a press fit. Following this, a valve needle is slid into the bearing bush pressed into the mounting bore, so that between a needle shank of the valve needle and the bearing bush a clearance fit is formed. The valve needle slid into the bearing bush is then provided with a separate fastening element so that the fastening element holds the needle in the bearing bush. Such a separate fastening element is usually realised as locking ring or as screw-on nut. Alternatively, the bearing bush can also be initially slid onto the needle shank of the valve needle and a separate fastening means for holding the valve needle in the bearing bush attached to the valve needle. Following this, the bearing bush, together with the valve needle received in the bearing bush, can be pressed into the mounting bore.

From JP 2008-32215 A a generic method for mounting a valve needle and a bearing bush in an expansion valve for an air conditioning system is known, with which initially a bearing bush is pressed into a mounting bore of the expansion valve. Following this, the valve needle is introduced into the bearing bush and fastened with a fastening element in the bearing bush in such a manner that the valve needle is moveable in an axial play. There, the valve needle is preloaded by means of a preload device which generates a preload force against which the valve needle is moveable in its axial play. Thus, a bringing into contact of the valve needle with a valve seat can be cushioned by means of the preload force of the preload element. Here, the fact that the fastening element and the valve needle have to be embodied as two separate components has to be seen as a disadvantage. This requires increased assembly effort and correspondingly high costs.

### SUMMARY

It is therefore an object of the present invention to show new ways for methods for mounting a valve needle and a bearing bush in an expansion valve for an air conditioning system and for expansion valves with valve needles and bearing bushes mounted in such a manner—in particular for eliminating the abovementioned disadvantages.

This object is solved through the subject matter of the independent claim(s). Preferred embodiments are subject matter of the dependent claim(s).

Accordingly, the basic idea of the invention is to mount a valve needle and a bearing bush, without an additional fastening element, in a mounting bore of an expansion valve provided for this purpose.

This offers the advantage that such an additional fastening element can be completely saved, which is directly accompanied by a cost saving in the amount of the costs of the additional fastening element. In addition to this, an elaborate fastening step of the valve needle in the bearing bush by means of such an additional separate fastening element during the mounting of the valve needle and of the bearing bush in the mounting bore of the expansion valve can be omitted, which brings with it further cost advantages.

According to the invention, a method for mounting a valve needle and a bearing bush in an expansion valve for an air conditioning system comprises four measures a) to d). Practically, such an expansion valve mounted by means of the method according to the invention can be used in an air conditioning system of a motor vehicle. The method comprises a first measure a), which provides that the bearing bush to be mounted is provided. Here, the bearing bush extends in an axial direction and comprises a circumferential wall, in which a slit-like opening extending along the axial direction is formed. Thus, the bearing bush is slit in the axial direction. In addition, the method comprises a further, second measure b), according to which the valve needle is provided. The valve needle extends in an axial direction and, at an axial end portion, comprises a receiving groove, which extends along a circumferential direction of the valve needle. The mounting groove is provided with two groove flanks located opposite one another in the axial direction, between which a groove base of the mounting groove is arranged. The groove base of the mounting groove practically forms a cylindrical portion of the valve needle. The method, furthermore, comprises a third measure c), in which an axial sliding-in of the valve needle into the bearing bush or an axial sliding-on of the bearing bush onto the valve needle takes place. By means of this sliding-in or sliding-on a needle-bush arrangement is formed, in which the bearing bush is received in the mounting groove of the valve needle. In addition to this, the method comprises a measure d), according to which the needle-bush arrangement is mounted in a mounting bore of the expansion valve provided for this purpose. This mounting of the needle-bush arrangement comprising the valve needle and the bearing bush takes place so that between the circumferential wall of the bearing bush and the mounting bore a press fit is formed. At the same time, a clearance fit is formed between the groove base of the mounting groove of the valve needle and of the bearing bush, which encloses the groove base. This means that following the carrying out of the method, in a mounted state of the valve needle and of the bearing bush in the expansion valve, a press fit between the mounting bore and the bearing bush is present and a clearance fit is formed between the bearing bush and the groove base of the valve needle. Advantageously, a mounting of a valve needle and of a bearing bush in an expansion valve can thus take place by means of the method according to the invention, without a separate fastening element for fastening the valve needle in the bearing bush being required. By way of this, the costs for such a fastening element as such can be saved on the one hand and an elaborate introducing of such a fastening element for fastening the valve needle omitted on the other hand. This brings with it substantial cost advantages compared with conventional methods for mounting a valve needle and a bearing bush in an expansion valve.

In a preferred further development of the method according to the invention, the mounting of the needle-bush arrangement in the mounting bore of the expansion valve takes place according to measure d) by means of axial pressing-in. Here, the bearing bush provided in measure a) has a bush outer diameter which is greater than a mounting inner diameter of the mounting bore of the expansion valve. Thus, the bearing bush, with the valve needle arranged in the bearing bush—i.e. the needle-bush arrangement—is forced along the axial direction into the mounting bore of the expansion valve for forming the press fit between the circumferential wall of the bearing bush and the mounting bore. Such a pressing-in of the needle-bush arrangement into the mounting bore of the expansion valve offers a possibility of the mounting of the needle-bush arrangement in the mounting bore of the expansion valve that is particularly easily realised. For this purpose, conventional pressing apparatuses can be advantageously employed, which renders carrying out the method particularly favourable under consideration of costs.

According to a further advantageous further development of the method, the bearing bush provided in measure a) extends in the axial direction over a bush length. The mounting groove of the valve needle provided in measure b) extends in the axial direction over a groove width. Here, the groove width of the mounting groove is greater than the bush length. Accordingly, an axial play of the valve needle relative to the bearing bush is formed during the mounting of the needle-bush arrangement according to measure d). In this axial play, the valve needle can be advantageously moved upon a bringing-into-contact of the valve needle with a valve seat. This means that the axial play forms a buffer path, which allows a particularly gentle butting of the valve needle against the valve seat.

Practically, a preload element is provided in the mounting bore of the expansion valve. This preload element is particularly practically formed as a coil spring element, i.e. as a coil spring. By means of the preload element, a preload force axially acting on the valve needle is generated during the mounting of the needle-bush arrangement according to measure d). The valve needle, in the mounted state achieved after the carrying out of the method, is moveable in its axial play relative to the bearing bush against this preload force of the preload element. Advantageously, it is achieved by means of the preload element that the valve needle, upon a forming of a contact of the valve needle with a valve seat, is moveable along its axial play and at the same time the forming of the contact can be cushioned. Here, the preload force causes a particularly favourably metered forming of the contact of the valve needle with the valve seat and ensures that the valve needle lies against the valve seat with an adequate sealing force. Here, the sealing force is practically generated by the preload element.

According to a further advantageous further development of the method, the axial sliding-in of the valve needle into the bearing bush or the axial sliding-on of the bearing bush onto the valve needle according to measure c) takes place by means of a pressing-in in the axial direction. Here, the valve needle comprises a shoulder on which one of the groove flanks of the mounting groove is present. The shoulder of the valve needle is embodied with a shoulder diameter which is greater than a bush inner diameter of a bush interior of the bearing bush delimited by the circumferential wall of the bearing bush. Accordingly, the shoulder of the valve needle is forced along the axial direction during the sliding-in or sliding-on of the valve needle into the bearing bush or the bearing bush onto the valve needle through the bush interior of the bearing bush. Advantageously, an axial stop is thus formed by means of the shoulder of the valve needle in the mounted state of the valve needle and of the bearing bush in the mounting bore of the expansion valve, which prevents that the valve needle can axially fall out of the bearing bush.

In an advantageous further development of the method, the preload force of the preload element is supported, during the mounting of the needle-bush arrangement in the mounting bore of the expansion valve, on a ledge of the shoulder of the valve needle facing away from the bearing bush. In the mounted state, the preload force of the preload element thus acts on the ledge of the shoulder facing away from the bearing bush. This makes possible a particularly good introducing of the preload force of the preload element onto the valve needle. Practically, a centring extension of the valve needle can be formed on the side of the ledge of the shoulder concentrically to the valve needle, by means of which the preload element is held concentrically to the valve needle in order to introduce the preload force as centrally as possible into the valve needle.

In a further advantageous further development, an introduction bevel is provided on an axial front side of the bearing bush towards the bush interior. Alternatively or additionally, an introduction bevel towards an outer lateral surface of the bearing bush is also provided on an axial front side. This means that on one of the two front sides of the bearing bush located opposite one another in the axial direction an introduction bevel either towards the bush interior or towards the outer lateral surface of the bearing bush can be provided. Compared with this, an introduction bevel towards the bush interior and towards the outer lateral surface can also be provided on both axial front sides. Advantageously, a particularly careful sliding-on of the bearing bush onto the valve needle or a particularly careful sliding-in of the valve needle into the bearing bush can thus be achieved. Likewise, a particularly careful mounting of the needle-bush arrangement in the mounting bore according to measure d) can advantageously take place with a comparatively low force expenditure. “Careful” is to mean that damaging the bearing bush such as scratching can be prevented or at least reduced. In addition to this, a developing of chips can be effectively reduced or even completely avoided.

Practically, an introduction bevel can be provided on the shoulder of the valve needle, particularly practically on the ledge of the shoulder facing away from the mounting groove. This makes possible a particularly careful sliding-on of the bearing bush onto the valve needle or a particularly careful sliding-in of the valve needle into the bearing bush. “Careful” is to mean that any damage of the bearing bush such as a scratching can be prevented or at least reduced. In addition to this, a creating of chips can be effectively reduced or even completely avoided.

In an advantageous further development of the method, an introduction bevel is provided on an edge of the mounting bore edging the mounting bore of the expansion valve. Advantageously, it is thereby achieved on the one hand that the mounting of the needle-bush arrangement in the mounting bore according to measure d) can be carried out particularly carefully and on the other hand that the force expenditure for mounting the needle-bush arrangement in the mounting bore can be advantageously reduced. Here, “careful” is to mean that any damage of the bearing bush such as a scratching can be prevented or at least reduced. In addition to this, a creating of chips can thus be effectively reduced or even completely avoided.

In a further advantageous further development of the method, the slit-like opening of the bearing bush running in the axial direction is spread open during the axial sliding-in of the valve needle into the bearing bush or during the axial sliding-on of the bearing bush onto the valve needle according to measure c). Advantageously, a shoulder of the valve needle having a shoulder diameter that is comparatively large relative to the bush inner diameter can thus be forced through the bush interior by means of the slit, since the bush inner diameter can be expanded. Such a comparatively large shoulder diameter is substantially larger than it would have to be for a conventional press fit pairing with a bore of the bush inner diameter. This makes possible a particularly reliable formation of the axial stop by means of the shoulder.

Practically the axially running slit-like opening of the bearing bush is narrowed during the mounting of the needle-bush arrangement in the mounting bore of the expansion valve according to measure d). Such a narrowing practically takes place elastically and/or plastically. Advantageously it is thus ensured that the bush inner diameter is reduced so that the axial stop formed by means of the shoulder of the needle can but-up against the bush in an improved manner. Apart from this, a particularly narrow clearance fit, i.e. a clearance fit which particularly precisely guides the needle, can be formed between the bearing bush and the valve needle in this way.

A further advantageous further development of the method provides that the method comprises an additional measure c1), which is carried out prior to the measure c) in time. According to this additional measure c1), the bearing bush is expanded so that the slit-like opening of the bearing bush is plastically spread open. This is accompanied by the bush inner diameter being enlarged. Thus, the shoulder of the valve needle can be forced through the bush interior in the measure c) with particularly little force expenditure, preferentially even without substantial force expenditure. This is accompanied by the sliding surface of the clearance fit between the bearing bush and the valve needle being protected. “Protected” here means that damage to the bearing bush such as scratching can be prevented or at least reduced. In addition to this, a development of chips can be effectively reduced or even completely avoided. Practically, the bearing bush provided in the measure a) is embodied so that the slit-like opening is closed during the mounting of the needle-bush arrangement in the mounting bore of the expansion valve. Particularly practically, the slit-like opening is completely closed during the mounting of the needle-bush arrangement. This means that after the method has been carried out the slit-like opening of the bearing bush is closed in the mounted state of the valve needle and the bearing bush in the expansion valve. Particularly practically, the slit-like opening of the bearing bush is completely closed in the mounted state. Advantageously, a particularly good sliding surface for the movement of the valve needle in its axial play is thereby provided, since a discontinuity of the sliding surface is eliminated or at least mitigated by the closing of the opening.

According to a further advantageous further development of the method, the mounting bore of the expansion valve, into which according to measure d) the needle-bush arrangement is forced, is provided on a hollow shaft of a rotor of the expansion valve that is moveable along the axial direction by means of a driving device and rotatable about the axial direction. By means of such a driving device, the entire needle-bush arrangement together with the hollow shaft can be moved in the direction of the valve seat along the axial direction for forming a contact with a valve seat.

Practically, the bearing bush provided in measure a) is formed from a bush material. This bush material preferentially comprises a spring steel or stainless steel with spring properties. Such a spring steel or stainless steel with spring properties can preferably be a steel designated 1.4310 according to DIN EN 10088. Furthermore, the bush material can alternatively or additionally comprise a copper alloy with spring properties. Such a bush material can comprise particularly good sliding properties which advantageously favours the movability of the valve needle along its axial play.

Furthermore, the invention relates to an expansion valve with a valve needle and a bearing bush, which are mounted by means of a method as described above. The advantages of the method shown above therefore also apply to the expansion valve according to the invention.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

It shows, in each case schematically:

FIG. 1 shows a flow diagram of an example of a method according to the invention for mounting a valve needle and a bearing bush in an expansion valve for an air conditioning system,

FIG. 2 shows a snapshot during the carrying out of the method of FIG. 1, exemplarily a sliding-in of the valve needle into the bearing bush or a sliding-on of the bearing bush onto the valve needle,

FIG. 3 shows a snapshot during the carrying out of the method of FIG. 1, exemplarily a needle-bush arrangement, which is formed as a consequence of the sliding-in or sliding-on shown in FIG. 2,

FIG. 4 shows a snapshot during the carrying out of the method according to FIG. 1, in a longitudinal section along an axial direction, an expansion valve with a mounting bore for receiving the needle-bush arrangement of FIG. 3,

FIG. 5 shows a longitudinal section along the axial direction, exemplarily an expansion valve according to the invention with the mounted valve needle and bearing bush after the carrying out of the method according to FIG. 1.

### DETAILED DESCRIPTION

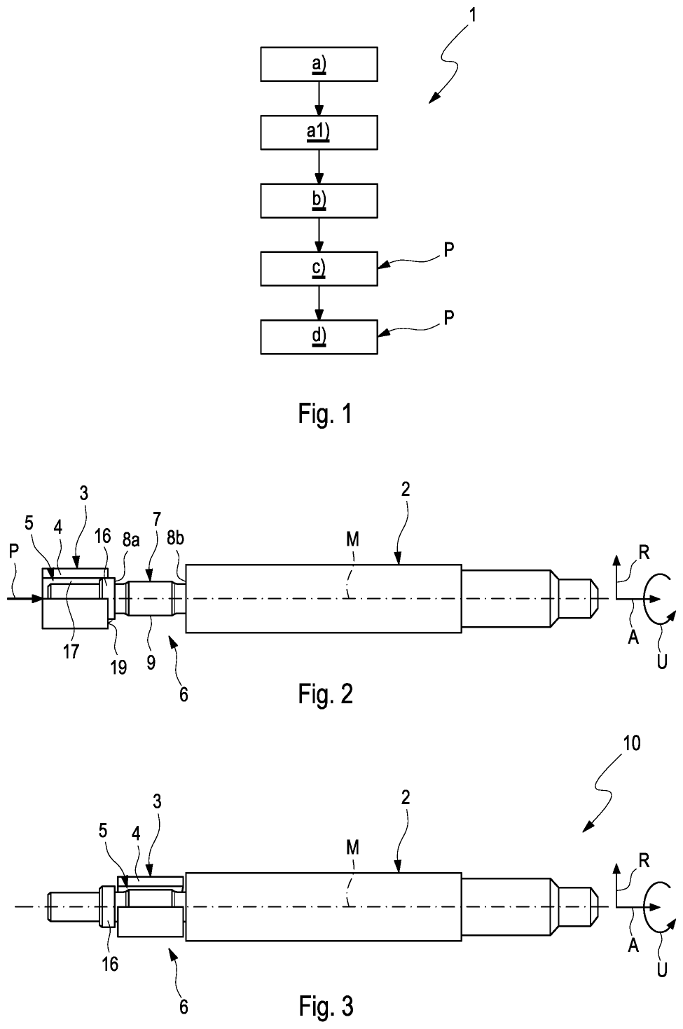

FIG. 1 shows a flow diagram of an example of a method 1 according to the invention for mounting a valve needle 2 and a bearing bush 3 in an expansion valve EV for an air conditioning system. Such an expansion valve EV can be installed for example in an air conditioning system of a motor vehicle.

In the FIGS. 2 and 3, snapshots during the carrying out of the method 1 according to FIG. 1 are exemplarily shown. Here, a sliding-in of the valve needle 2 into the bearing bush 3 or a sliding-on of the bearing bush 3 onto the valve needle 2 are shown in FIG. 2 and a needle-bush arrangement 10 in FIG. 3, which is formed as a consequence of the sliding-in or sliding-on shown in FIG. 2. As is exemplarily understandable by way of the FIGS. 2 and 3, the bearing bush 3 that can be mounted by means of the method 1 according to the invention extends along an axial direction A and has a circumferential wall 4. The axial direction A can run on a centre longitudinal axis of the bearing bush. From the axial direction A, a radial direction R can extend away perpendicularly. A circumferential direction U can circulate round about the centre longitudinal axis M and extend perpendicularly to the axial direction A and to the radial direction R. In the circumferential wall 4 a slit-like opening 5 is formed, which extends along the axial direction A. According to the examples of FIGS. 2 and 3, the bearing bush 3 can be embodied with a slit-like opening 5 running along the axial direction A, which completely separates the circumferential wall 4 of the bearing bush 3 along the axial direction A. However, the slit-like opening 5 can also be formed so as to only partially sever the circumferential wall 4 of the bearing bush 3 in the axial direction 4, which is not shown. Furthermore, multiple slit-like openings 5 can also be provided in the circumferential wall 4 of the bearing bush 3, which in each case only penetrate one of the front faces 19 of the bearing bush 3. The valve needle 2 likewise extends along an axial direction A. The valve needle 2 comprises an axial end portion 6 in which a mounting groove 7 extending along the circumferential direction U of the valve needle 2 is present. This mounting groove 7 comprises two groove flanks 8a, 8b located opposite one another in the axial direction A. Between the groove flanks 8a, 8b located opposite one another a groove base 9 of the mounting groove 7 is formed.

According to the example of FIG. 1, the method comprises a first measure a), according to which the bearing bush 3 is provided. In a measure c1), the bearing bush 3 can be expanded so that the slit-like opening 5 of the bearing bush 3 is elastically spread open. Furthermore, the method comprises a measure b) which provides that the valve needle 2 is provided. In a further measure c), an axial sliding-in of the valve needle 2 into the bearing bush 3 or an axial sliding-on of the bearing bush 3 onto the valve needle 2 takes place.

By means of this sliding-in or sliding-on, which is exemplarily illustrated as snapshot in FIG. 2, a needle-bush arrangement 10 is formed. The axial sliding-in of the valve needle 2 into the bearing bush 3 or the axial sliding-on of the bearing bush 3 onto the valve needle 2 according to measure c) can take place by means of a pressing-in P in the axial direction A. During the axial sliding-in of the valve needle 2 into the bearing bush 3 or during the axial sliding-on of the bearing bush 3 onto the valve needle 2, the slit-like opening 5 of the bearing bush 3 running in the axial direction A can be spread open. Such a spreading-open of the slit-like opening 5 can take place elastically and/or plastically.

The resulting needle-bush arrangement 10 is exemplarily illustrated in FIG. 3. In the needle-bush arrangement 10, the bearing bush 3 is received in the mounting groove 7 of the valve needle 2.

According to FIG. 1, the method according to the invention additionally comprises a measure d), according to which the needle-bush arrangement 10 is mounted in a mounting bore 11 of an expansion valve EV provided for this purpose. This means that the valve needle 2 and the bearing bush 3 are jointly mounted in the mounting bore 11.

According to the measure d), the needle-bush arrangement 10 is mounted so that a mounted state of the expansion valve EV illustrated in FIG. 5 is formed. In this mounted state of the expansion valve EV, a press fit 12 is formed between the circumferential wall 4 of the bearing bush 3 and the mounting bore 11 of the expansion valve EV. Between the groove base 9 of the mounting groove 7 and the bearing bush 3, a clearance fit 13 is formed in the mounted state. The mounting of the needle-bush arrangement 10 in the mounting bore 11 of the expansion valve according to measure d) for creating the mounted state, can take place in the manner of an axial pressing-in P.

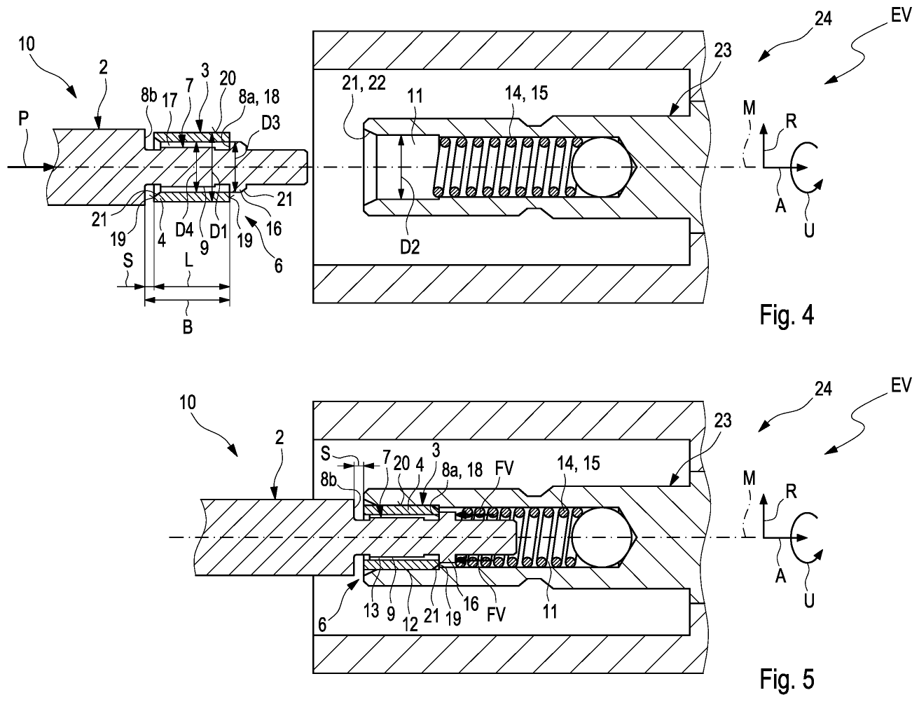

There, corresponding to the example of FIG. 4, the bearing bush 3 can have a bush outer diameter D1, which is greater than a mounting inner diameter D2 of the mounting bore 11 of the expansion valve EV. Accordingly, when carrying out the measure d), the bearing bush 3 together with the valve needle 2 arranged in the bearing bush 3, can be forced along the axial direction A into the mounting bore 11 of the expansion valve EV for forming the press fit 12 between the circumferential wall 4 of the bearing bush 3 and the mounting bore 11. The bearing bush 3 provided in measure a) can extend in the axial direction A over a bush length L. The mounting groove 7 of the valve needle 2 provided in measure b) can extend in the axial direction A over a groove width B. The groove width B can be greater than the bush length L.

In the FIGS. 4 and 5 it is shown that in the mounting bore 11 of the expansion valve EV a preload element 14 is provided. According to the examples shown, such a preload element 14 can be a coil spring element 15 embodied as coil spring. During the mounting of the needle-bush arrangement 10 according to the measure d), a preload force FV axially acting on the valve needle 2 can be generated by means of the preload element 14. During the mounting of the needle-bush arrangement 10 according to the measure d), an axial play S of the valve needle 2 can be formed relative to the bearing bush 3 as shown in FIG. 5.

In the mounted state shown in FIG. 5, the valve needle 2 can be moveable in its axial play S relative to the bearing bush 3 against the preload force FV. By means of the preload force FV of the preload element 14, a bringing-into-contact of the valve needle 2 with a valve seat—not shown in the figures—can be cushioned. Such a cushioning can take place over a distance of the play S.

On the valve needle 2 a shoulder 16 can be present, on which one of the groove flanks 8a, 8b of the mounting groove 7 is arranged. As shown in FIG. 4, the shoulder 16 of the valve needle 2 can be embodied with a shoulder diameter D3. The shoulder diameter D3 can be greater than a bush inner diameter D4 of a bush interior 17 of the bearing bush 3 delimited by the circumferential wall 4 of the bearing bush 3. Accordingly, when carrying out the measure c), the shoulder 18 can be forced along the axial direction A through the bush interior of the bearing bush 3.

As is evident in FIG. 5, the preload force FV of the preload element 14 can be introduced, during the mounting of the needle-bush arrangement 10 in the mounting bore 11 of the expansion valve EV, on a ledge 18 of the shoulder 16 of the valve needle 2 into the valve needle 2, wherein the ledge 18 of the shoulder 16 can be facing away from the bearing bush 3. In the mounted state, the preload force FV of the preload element 14 can be introduced into the valve needle 2 on the ledge 18 of the shoulder 16 of the valve needle 2 facing away from the bearing bush 3.

As illustrated in FIG. 4, an introduction bevel 21 can be provided on an axial front side 19 of the bearing bush 3 towards the interior 17. Alternatively or additionally, an introduction bevel 21 can also be provided on the axial front side 19 towards an outer lateral surface 20 of the bearing bush 3. One of the two front sides 19 of the bearing bush 3 can be embodied with an introduction bevel 21 towards the bush interior 17 and the other front side 19 of the bearing bush 3 located opposite can be provided with an introduction bevel towards the outer lateral surface 20 of the bearing bush 3. Alternatively it is also possible to provide an introduction bevel with front sides 19 of the bearing bush 3 both towards the outer lateral surface 20 and also towards the interior 17, which however is not shown in the figures. On the shoulder 16 of the valve needle 2 an introduction bevel 21 can likewise be provided. This introduction bevel 21 on the shoulder 16 of the valve needle 2 can be present on the shoulder 18 of the bevel 16 of the valve needle 2 facing away from the bearing bush 3. On an edge 22 of the mounting bore 11 edging the mounting bore 11 of the expansion valve EV, an introduction bevel 21 can likewise be provided.

When mounting the needle-bush arrangement 10 in the mounting bore 11 of the expansion valve EV according to measure d), the axially running slit-like opening 5 of the bearing bush 3 can be narrowed, so that the slit-like opening 5 of the bearing bush 3 is narrowed in the mounted state shown in FIG. 5. Such a narrowing of the slit-like opening 5 in measure d) can take place elastically and/or plastically. The bearing bush 3 provided in measure a) can be embodied so that the slit-like opening 5 during the mounting of the needle-bush arrangement 10 in the mounting bore 11 of the expansion valve EV for creating the mounted state can be closed. Here, the slit-like opening 5 can be completely closed. In the mounted state of the valve needle 2 and the bearing bush 3 in the expansion valve EV, the slit-like opening 5 of the bearing bush 3 can be closed. The slit-like opening 5 can be completely closed in the mounted state.

According to the examples of FIGS. 4 and 5, the mounting bore 11 of the expansion valve EV, into which the needle-bush arrangement 10 is forced according to measure d), can be provided on a hollow shaft 23. This hollow shaft 23 can be provided on a rotor 24 of the expansion valve EV. The rotor 24 with the hollow shaft 23 can be moveable by means of a driving device along the axial direction A and rotatable about the axial direction A. The mounting bore 11 can be a blind hole. The preload element 14 can be axially supported on a base of the mounting bore 11 embodied as blind hole. The preload element 14 can be supported on the base of the mounting bore 11 embodied as blind hole by a sphere. This sphere can have an outer diameter matched to the mounting inner diameter D2 of the mounting bore 11.

Alternatively to the formation of the mounting bore 11 as blind hole shown in the FIGS. 4 and 5, the mounting bore can also be a through-bore, wherein for axially supporting the preload element 14 a narrowing of the mounting inner diameter D2 can be provided. The bearing bush 3 provided in measure a) can be formed from a bush material. This bush material of the bearing bush 3 can comprise a spring steel or stainless steel with spring properties. Such a spring steel or stainless steel with spring properties can in particular be a steel designated 1.4310 according to DIN EN 10088. Furthermore, the bush material of the bearing bush 3 can alternatively or additionally comprise a copper alloy with spring properties.

FIG. 5, furthermore, shows as part view an example of an expansion valve EV according to the invention in a longitudinal section along the axial direction A with a valve needle 2 and a bearing bush 3, which are mounted by means of the method one described above.

1. A method for mounting a valve needle and a bearing bush in an expansion valve for an air conditioning system, comprising:
providing the bearing bush, the bearing bush extending in an axial direction and including a circumferential wall in which a slit-like opening is disposed, the slit-like opening extending along the axial direction;
providing the valve needle, the valve needle extending along the axial direction, the valve needle including a mounting groove disposed at an axial end portion of the valve needle and extending along a circumferential direction of the valve needle, the mounting groove including two groove flanks disposed opposite one another in the axial direction and a groove base arranged between the two groove flanks;
forming a needle-bush arrangement in which the bearing bush is received in the mounting groove of the valve needle via at least one of (i) axial sliding-in the valve needle into the bearing bush and (ii) axial sliding-on the bearing bush onto the valve needle;
mounting the needle-bush arrangement in a mounting bore of the expansion valve; and
wherein mounting the needle-bush arrangement in the mounting bore includes:
forming a press fit between the circumferential wall of the bearing bush and the mounting bore; and
forming a clearance fit between the groove base of the mounting groove and the bearing bush.

2. The method according to claim 1, wherein:
the bearing bush has a bush outer diameter which is greater than a mounting inner diameter of the mounting bore of the expansion valve; and
mounting the needle-bush arrangement in the mounting bore of the expansion valve includes axial pressing-in and forcing the bearing bush with the valve needle along the axial direction into the mounting bore of the expansion valve to form the press fit.

3. The method according to claim 1, wherein:
the bearing bush extends in the axial direction over a bush length;
the mounting groove of the valve needle extends in the axial direction over a groove width;
the groove width is greater than the bush length; and
mounting the needle-bush arrangement includes forming an axial play of the valve needle relative to the bearing bush.

4. The method according to claim 3, further comprising:
providing the mounting bore of the expansion valve with a preload element; and
while mounting the needle-bush arrangement, generating a preload force with the preload element, the preload force axially acting on the valve needle and against which the valve needle is moveable in the axial play relative to the bearing bush.

5. The method according to claim 1, wherein:
the valve needle includes a shoulder that defines at least one of the two groove flanks of the mounting groove;
the shoulder has a shoulder diameter which is greater than a bush inner diameter of a bush interior delimited by the circumferential wall of the bearing bush; and
the at least one of (i) axial sliding-in the valve needle into the bearing bush and (ii) axial sliding-on the bearing bush onto the valve needle, includes pressing-in in the axial direction such that the shoulder, along the axial direction, is forced through the bush interior of the bearing bush.

6. The method according to claim 4, wherein generating the preload force includes introducing the preload force on a ledge of a shoulder of the valve needle facing away from the bearing bush and into the valve needle.

7. The method according to claim 5, further comprising providing an introduction bevel on an axial front side of the bearing bush such that the introduction bevel faces at least one of towards the bush interior and towards an outer lateral surface of the bearing bush.

8. The method according to claim 5, further comprising providing an introduction bevel on the shoulder of the valve needle.

9. The method according to claim 1, further comprising providing an introduction bevel on an edge of the mounting bore edging the mounting bore.

10. The method according to claim 1, further comprising spreading open the slit-like opening of the bearing bush during the at least one of (i) axial sliding-in the valve needle into the bearing bush and (ii) axial sliding-on the bearing bush onto the valve needle.

11. The method according to claim 1, further comprising narrowing the slit-like opening of the bearing bush during the mounting of the needle-bush arrangement in the mounting bore of the expansion valve.

12. The method according to claim 1, further comprising, prior to forming the needle-bush arrangement, widening the bearing bush such that the slit-like opening of the bearing bush is plastically spread open.

13. The method according to claim 1, wherein, during the mounting of the needle-bush arrangement in the mounting bore of the expansion valve, the slit-like opening is completely closed such that in a mounted state of the valve needle and of the bearing bush in the expansion valve the slit-like opening of the bearing bush is completely closed.

14. The method according to claim 1, further comprising providing the mounting bore of the expansion valve on a hollow shaft of a rotor of the expansion valve that is moveable along the axial direction via a driving device and rotatable about the axial direction.

15. The method according to claim 1, wherein the bearing bush is composed of a bush material that includes at least one of (i) a spring steel, (ii) a stainless steel with spring properties, and (iii) a copper alloy with spring properties.

16. An expansion valve, comprising the valve needle and the bearing bush mounted via the method of claim 1.

17. The method according to claim 1, further comprising elastically spreading open the slit-like opening of the bearing bush during the at least one of (i) axial sliding-in the valve needle into the bearing bush and (ii) axial sliding-on the bearing bush onto the valve needle.

18. The method according to claim 1, further comprising elastically narrowing the slit-like opening of the bearing bush during the mounting of the needle-bush arrangement in the mounting bore of the expansion valve.

19. The method according to claim 1, further comprising plastically narrowing the slit-like opening of the bearing bush during the mounting of the needle-bush arrangement in the mounting bore of the expansion valve.

20. A method of mounting a valve needle and a bearing bush in an expansion valve for an air conditioning system, comprising:
providing the bearing bush, the bearing bush extending in an axial direction and including a circumferential wall in which a slit-like opening is disposed, the slit-like opening extending along the axial direction;
providing the valve needle, the valve needle extending along the axial direction, the valve needle including a circumferential mounting groove disposed at an axial end portion of the valve needle, the mounting groove including two groove flanks disposed opposite one another in the axial direction and a groove base extending between the two groove flanks;
arranging a coil spring in a mounting bore of the expansion valve;
engaging the bearing bush in the mounting groove of the valve needle to form a needle-bush arrangement via at least one of (i) axial sliding the valve needle into the bearing bush and (ii) axial sliding the bearing bush onto the valve needle;
mounting the needle-bush arrangement in the mounting bore of the expansion valve such that the valve needle is disposed with axial play relative to the bearing bush; and
wherein mounting the needle-bush arrangement in the mounting bore includes:
generating, via the coil spring, a preload force that acts axially on the valve needle;
forming a press fit between the circumferential wall of the bearing bush and the mounting bore; and
forming a clearance fit between the groove base of the mounting groove and the bearing bush.
